(19) United States
(12) Patent Application Publication
(10) Pub. No.: US 2016/0132909 A1
(43) Pub. Date: May 12, 2016

(54) Systems and Methods for Candidate Tracking

(71) Applicant: Recruit Tracker, Inc., San Francisco, CA (US)

(72) Inventors: Jon Guidi, San Francisco, CA (US); Nick Ellis, San Francisco, CA (US); Mislav Malenica, Zagreb (HR); Mike Mayes, San Francisco, CA (US); Radomir Stevanovic, Osijek (HR); Tomislav Lombarovic, Otok (HR)

(73) Assignee: Recruit Tracker, Inc.

(21) Appl. No.: 14/937,312

(22) Filed: Nov. 10, 2015

Related U.S. Application Data
(60) Provisional application No. 62/077,509, filed on Nov. 10, 2014.

(51) Int. Cl. G06Q 30/02; G06Q 30/00

(52) U.S. Cl. CPC G06Q 30/0202; G06Q 30/01

(57) ABSTRACT

Systems and methods for candidate tracking and fee recovery in accordance with embodiments of the invention are disclosed. In one embodiment, a candidate tracking server system includes a processor and a memory storing a candidate tracking application directing the processor to obtain candidate data describing a candidate, identify at least one publicly available data source system, obtain public activity data for the candidate data from the at least one publicly available data source system, determine current employment status data for the candidate data based on the obtained public activity data, calculate fee opportunity data based on the candidate data, current employment status data, and staffing firm data, determine if the fee opportunity data has been fulfilled, and when the fee opportunity data has not been fulfilled, generate notification data including the fee opportunity data and metadata describing the employer and the staffing firm and provide the generated notification data.

### CROSS-REFERENCE TO RELATED APPLICATIONS

The instant application claims priority of U.S. Provisional Patent Application No. 62/077,509, titled “Systems and Methods for Candidate Tracking” and filed Nov. 10, 2014, the disclosure of which is hereby incorporated by reference in its entirety.

### FIELD OF THE INVENTION

The present invention relates to recovering fees and more specifically to tracking candidate placement and recruitment performance.

### BACKGROUND

Customer Relationship Management (CRM) systems are commonly employed to manage a variety of contacts with one or more companies. Generally, information can be accessed and entered by employees of the company. Applicant Tracking Systems (ATS) facilitate intake and tracking of applicants to one or more companies. Many companies (i.e. employers) utilize staffing firms to identify potential employees. Recruiters post job openings, collect resumes from prospective employees, and conduct initial interviews of the prospective employee. The recruiter then recommends one or more potential employees to the companies.

Staffing firms have contracts with hiring companies that stipulate the staffing firm's right to collect a fee if the candidate they introduced to the hiring company is hired within a certain number of months. Currently it is very difficult to enforce this contractual provision, and many staffing firms fail to collect fees owed to them by hiring companies who ultimately hire candidates introduced by the staffing firm.

### SUMMARY OF THE INVENTION

Systems and methods for candidate tracking and fee recovery in accordance with embodiments of the invention are disclosed. In one embodiment, a candidate tracking server system includes a processor and a memory connected to the processor and storing a candidate tracking application, wherein the candidate tracking application directs the processor to obtain candidate data describing a candidate, identify at least one publicly available data source system associated with the candidate data, obtain public activity data for the candidate data from the at least one publicly available data source system, determine current employment status data for the candidate data based on the obtained public activity data, calculate fee opportunity data based on the candidate data, current employment status data, and staffing firm data, where the staffing firm data describes a relationship between an employer identified in the current employment status data and a staffing firm, determine if the fee opportunity data has been fulfilled, and when the fee opportunity data has not been fulfilled, generate notification data including the fee opportunity data and metadata describing the employer and the staffing firm and provide the generated notification data.

In another embodiment of the invention, the notification data is provided via e-mail.

In an additional embodiment of the invention, the notification data is transmitted to a customer relationship management system provided by the employer.

In yet another additional embodiment of the invention, the at least one publicly available data source system includes an online social network.

In still another additional embodiment of the invention, the public activity data includes a set of keywords.

In yet still another additional embodiment of the invention, the current employment status data is determined by parsing the public activity data to identify keywords describing the employer.

In yet another embodiment of the invention, the candidate tracking application further directs the processor to generate probability data based on the candidate data and the publicly available data, where the probability data includes a score indicating the likelihood a candidate will leave their current job.

In still another embodiment of the invention, the candidate tracking application further directs the processor to generate psychological profile data based on the candidate data and the publicly available data, where the psychological profile data includes a set of scores.

In yet still another embodiment of the invention, the staffing firm data further includes metadata identifying a recruiter associated with the candidate data and the employer and the candidate tracking application further directs the processor to calculate a set of recruiter performance scores based on the fee opportunity data.

In yet another additional embodiment of the invention, the recruiter performance scores are selected from the group consisting of a score describing the value of missed fee opportunities and a score describing a ratio of candidate placements to missed fee opportunities.

Still another embodiment of the invention includes a method for tracking candidates including obtaining candidate data describing a candidate using a candidate tracking server system, where the candidate tracking server system includes a processor and a memory connected to the processor, identifying at least one publicly available data source system associated with the candidate data using the candidate tracking server system, obtaining public activity data for the candidate data from the at least one publicly available data source system using the candidate tracking server system, determining current employment status data for the candidate data based on the obtained public activity data using the candidate tracking server system, calculating fee opportunity data based on the candidate data, current employment status data, and staffing firm data using the candidate tracking server system, where the staffing firm data describes a relationship between an employer identified in the current employment status data and a staffing firm, determining if the fee opportunity data has been fulfilled using the candidate tracking server system, and, when the fee opportunity data has not been fulfilled, generating notification data including the fee opportunity data and metadata describing the employer and the staffing firm using the candidate tracking server system and providing the generated notification data using the candidate tracking server system.

In yet another additional embodiment of the invention, the notification data is provided via e-mail.

In still another additional embodiment of the invention, the notification data is transmitted to a customer relationship management system provided by the employer.

In yet still another additional embodiment of the invention, the at least one publicly available data source system includes an online social network.

In yet another embodiment of the invention, the public activity data includes a set of keywords.

In still another embodiment of the invention, the current employment status data is determined by parsing the public activity data to identify keywords describing the employer.

In yet still another embodiment of the invention, the method further includes generating probability data based on the candidate data and the publicly available data using the candidate tracking server system, where the probability data includes a score indicating the likelihood a candidate will leave their current job.

In yet another additional embodiment of the invention, the method further includes generating psychological profile data based on the candidate data and the publicly available data using the candidate tracking server system, where the psychological profile data includes a set of scores.

In still another additional embodiment of the invention, the method further includes calculating a set of recruiter performance scores based on the fee opportunity data using the candidate tracking server system, wherein the staffing firm data further includes metadata identifying a recruiter associated with the candidate data and the employer.

In yet still another additional embodiment of the invention, the recruiter performance scores are selected from the group consisting of a score describing the value of missed fee opportunities and a score describing a ratio of candidate placements to missed fee opportunities.

### BRIEF DESCRIPTION OF THE DRAWINGS

FIG. 1 is a conceptual illustration of a candidate tracking system in accordance with an embodiment of the invention.

FIG. 2 is a conceptual illustration of a candidate tracking server system in accordance with an embodiment of the invention.

FIGS. 3A-B are conceptual illustrations of user interfaces for reporting candidate placement fee data in accordance with an embodiment of the invention.

FIG. 3C is a flow chart illustrating a process for determining candidate placement fee data in accordance with an embodiment of the invention.

FIG. 4 is a flow chart illustrating a process for tracking candidate data in accordance with an embodiment of the invention.

FIG. 5A is a conceptual illustration of a system for predicting future candidate behavior in accordance with an embodiment of the invention.

FIG. 5B is a flow chart illustrating a process for predicting future behavior of candidates in accordance with an embodiment of the invention.

FIG. 6 is a flow chart illustrating a process for tracking recruiter performance in accordance with an embodiment of the invention.

### DETAILED DESCRIPTION

Turning now to the drawings, systems and methods for candidate tracking and fee recovery in accordance with embodiments of the invention are disclosed. Staffing firms commonly represent a large number of candidates (i.e. employees and/or potential employees) and employers (e.g. hiring companies). However, it can be incredibly complex to track every candidate along with each submission of the candidates to multiple employers. Furthermore, it is not uncommon for candidates who are not initially hired by an employer to be later hired by the same employer within a contractual fee period, potentially under a different employment arrangement than first envisioned (i.e. as a “contractor” or “temporary” worker as opposed to a full-time employee). In many embodiments, a contractual fee period is an agreed on time frame between a staffing firm and an employer in which, if the employer is to hire a candidate referred by the staffing firm, the employer will pay a fee to the staffing firm. Many staffing firms maintain private databases of candidate and employer information in order to help them keep track of their staffing activities. In a variety of embodiments, recruiters working for a staffing firm are evaluated based on the number of candidates placed and the number of placement fees that remain uncollected.

Candidate tracking systems in accordance with embodiments of the invention reconcile private staffing firm data with publicly available data in order to identify potential missed fee opportunities. By comparing private employment data kept by the staffing firm with publicly available professional information online, candidate tracking systems can identify candidates who secured jobs based on a staffing firm's introduction to a particular employer. This publicly available and private staffing firm data can be correlated with employer data describing the staffing firm's contractual status with respect to an employer to determine if a fee is owed. The fee arrangement can be any agreed-on fee between the employer and the staffing firm, such as a flat fee, a percentage of the first-year salary paid to the candidate, a fee based on the experience level of the candidate, a demand-based fee, or any other fee and/or signing bonus as appropriate to the requirements of specific applications of the invention. If necessary, the candidate tracking system can notify the staffing firm and/or employer by providing notification data via any of a variety of communication channels, such as e-mail and by providing the notification directly to the employer's internal server systems. The employer server systems can include, but are not limited to, payroll systems and/or customer relationship management (CRM) systems.

In a variety of embodiments, the staffing firm data is stored using a staffing firm database system such as any of a variety of CRM systems and/or applicant tracking systems (ATS). Public activity data (i.e. the publically available data describing the current employment status of one or more candidates) can be obtained from any of a variety of third party content services, such as online social networks such as the Facebook service provided by Facebook, Inc. of Menlo Park, Calif., the LinkedIn service provided by the LinkedIn Corporation of Mountain View, Calif., the Twitter service provided by Twitter Inc. of San Francisco, Calif., the Data.com Connect service provided by Salesforce, Inc. of San Francisco, Calif., and the Zoominfo service provided by Zoom Information, Inc. of Waltham, Mass. However, it should be noted that any third party content service, such as personal blogs or message boards, that provides data describing a relationship between an employee and an employer can be utilized as appropriate to the requirements of specific applications of the invention. Additionally, search engine providers can be utilized to identify sources of publicly available data along with publicly available data itself. In this way, a variety of potentially unknown sources of publicly available data can be identified. In a variety of embodiments, employee email addresses are validated for particular employers consistent with potential candidate employment locations to verify employment at a particular employer. This can allow for a publicly available email address to be used to verify a place of employment for a particular employee.

Systems and methods for tracking the employment status of candidates and identifying fee recovery opportunities in accordance with embodiments of the invention are discussed in detail below.

### Candidate Tracking Systems

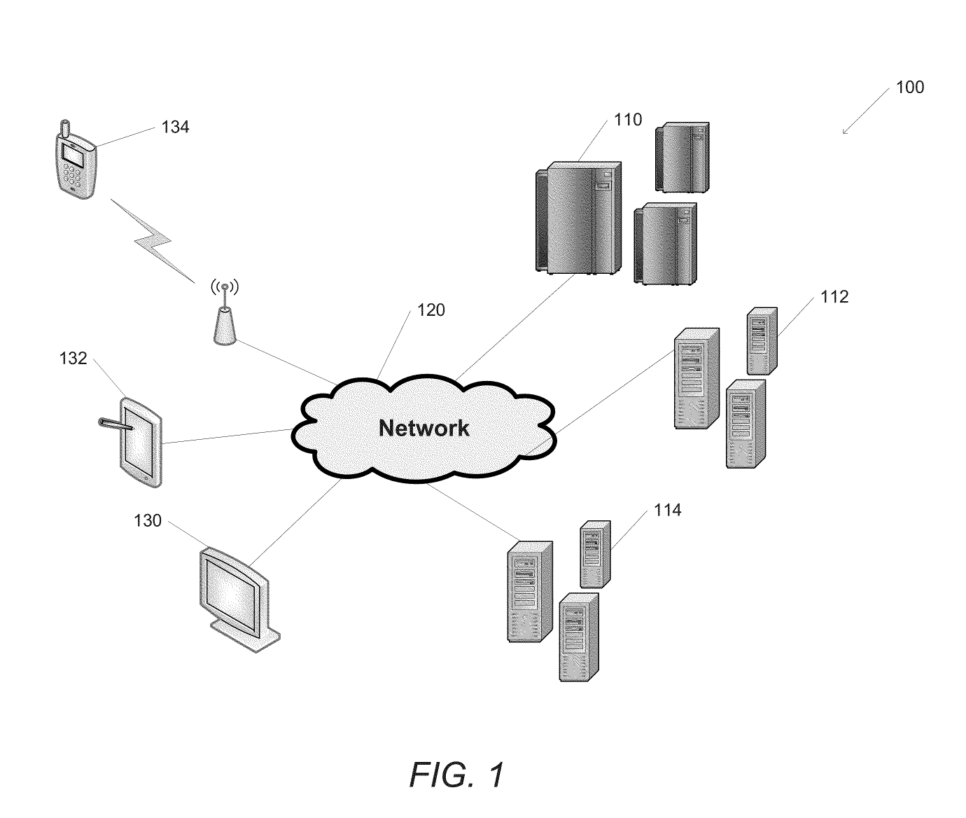

Candidate tracking systems in accordance with embodiments of the invention can correlate publicly-available data regarding candidates, hiring managers, and recruiters, and private employment data in order to identify cases where an employer may owe a fee, such as a referral fee and/or a signing bonus fee, to a staffing firm. A conceptual diagram of a candidate tracking system in accordance with an embodiment of the invention is shown in FIG. 1. The candidate tracking system 100 includes a candidate tracking server system 110, a staffing firm database system 112, third party content systems 114, and user devices including computers 130, tablets 132, and mobile phones 134 communicating via a network 120. In a variety of embodiments, the network 120 is the Internet. In a number of embodiments, the candidate tracking server system 110 and/or the staffing firm database system 112 are implemented using a single server system. In several embodiments, the candidate tracking server system 110 and/or staffing firm database system 112 are implemented using multiple server systems.

The candidate tracking server system 110 can obtain private employment data (e.g. private data regarding candidates) and public activity data (e.g. publicly available data describing a candidate's current job search and/or employment status) and perform a variety of candidate tracking processes using the obtained data. Additionally, the candidate tracking server system 110 can utilize the obtained data to provide guidance regarding the future behavior of candidates. In a variety of embodiments, the staffing firm data is obtained from the staffing firm database 112 and the public activity data is obtained from the third party content system 114. It should be noted that the staffing firm data and the public activity data can be obtained from any system in any manner (i.e. via one or more application programming interfaces (APIs) or web services) appropriate to the requirements of specific applications of embodiments of the invention.

In several embodiments, the candidate tracking server system 110 can receive requests to perform and/or provide the results of the candidate tracking processes to the user devices, the staffing firm database system 112, and/or the third party content systems 114. In a number of embodiments, the candidate tracking server system 110 can present the results to one or more employers notifying them of a fee that could be owed to a staffing firm. However, it should be noted that the notification of potential fees, other compensation, and/or any other notification with respect to the movement and employment location of particular employees can be provided as appropriate to the requirements of specific applications of embodiments of the invention.

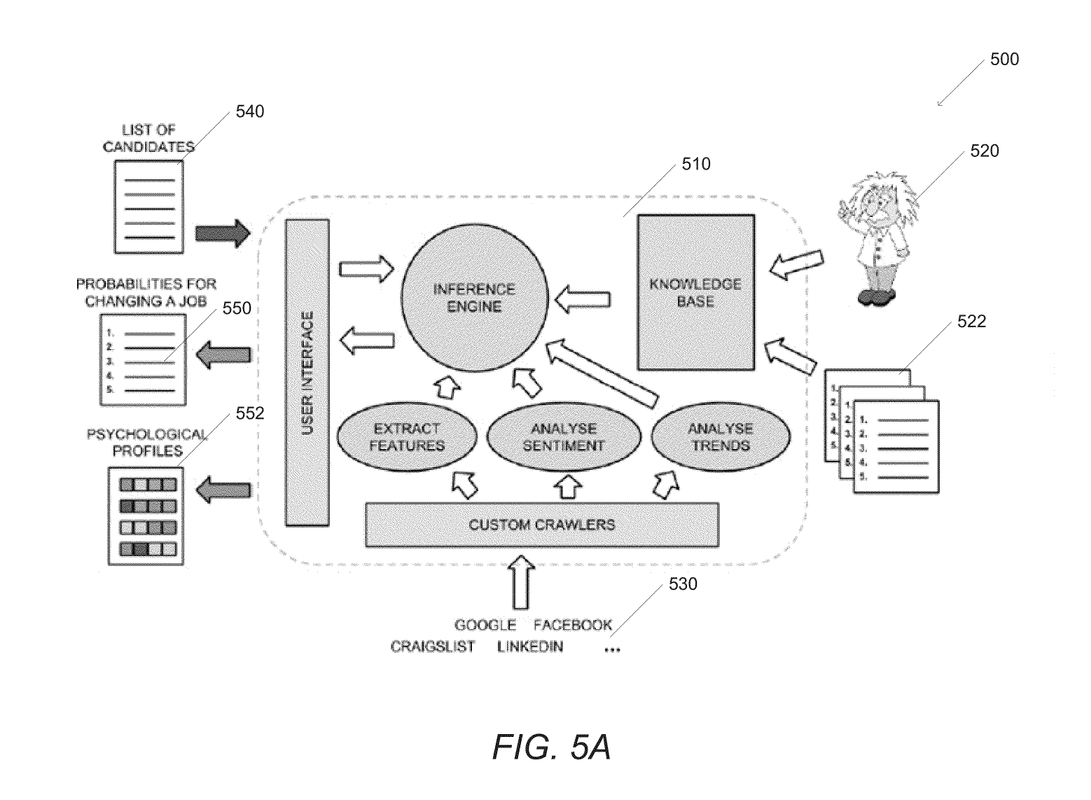

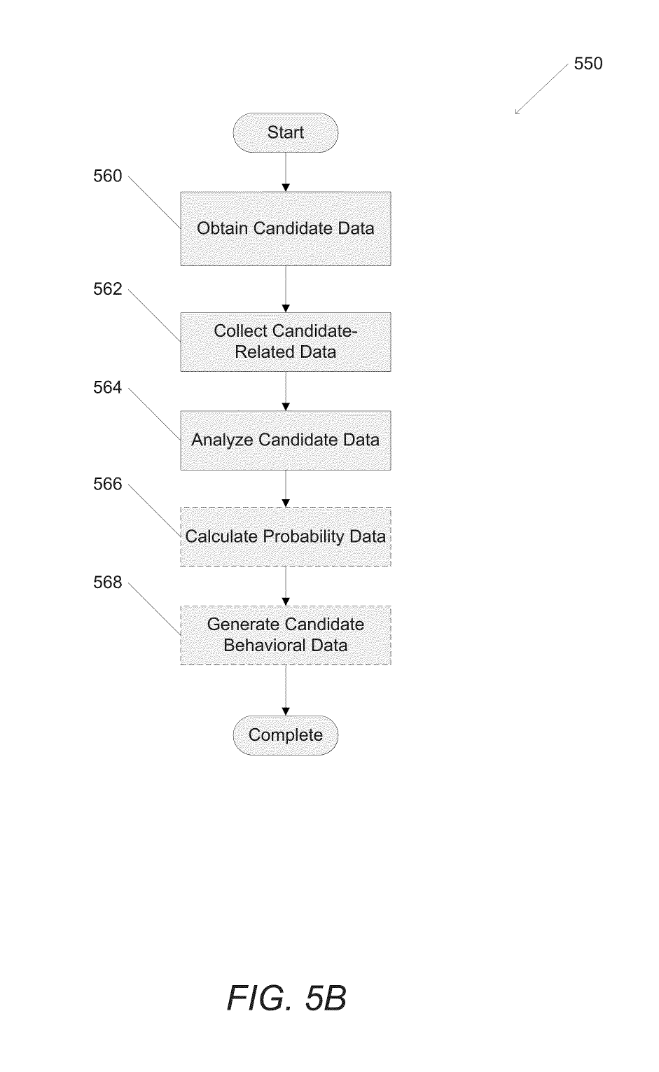

A candidate tracking system for predicting candidate's future behavior in accordance with an embodiment of the invention is conceptually illustrated in FIG. 5A. The candidate tracking system 500 includes a candidate tracking server system 510 having a variety of sub-systems and interfaces. These sub-systems include, but are not limited to, a knowledge database, crawler application programming interfaces (APIs), one or more inference engines, and APIs for accepting candidate data and providing data analyzing features of the candidate data. In a number of embodiments, the crawler APIs are capable of requesting data from and/or receiving data from a variety of publicly-available data sources 530, such as online social networks, search engine provides, online listing databases, and any other publicly-available third party system as appropriate to the requirements of specific applications of embodiments of the invention. The data received using the crawler APIs can include any publicly available data such as that described above. The knowledge database can include one or more APIs capable of requesting data from and/or receiving data from a variety of knowledge systems, such as expert data sources 520 and historical databases 522. The expert data sources 520 can include a variety of human-powered and machine-generated analysis of a variety of employee behaviors based on a set of training data. Similarly, the historical databases 522 can include a variety of records regarding sets of employees and their employment history. The knowledge database can then be utilized to identify trends and/or features in the expert data and/or historical data and compare those trends to particular keywords and/or attributes in the candidate data. These trends and/or features can be utilized by an inference engine to identify potential behaviors in a set of received candidate data 540. The candidate data 540 can be obtained using a variety of APIs and can include any data describing a set of candidates as described herein. The identified potential behaviors can include a set of probability data 542 describing the chance a particular candidate will leave their current job and/or potential locations for future employment. Psychological profile data 544 can also be generated for particular candidates based on the candidate data, expert data, historical data, and publicly available data for a particular candidate and/or set of candidates. This psychological profile data 544 can be utilized in a variety of ways as appropriate to the requirements of specific applications of embodiments of the invention, such as by providing additional metadata to match candidates to potential future employers.

Although specific architectures of candidate tracking systems in accordance with embodiments of the invention are discussed above and illustrated in FIG. 1 and FIG. 5, a variety of architectures, including user devices not specifically named, other methods of obtaining publicly and/or privately available data, and candidate tracking systems that combine features as described above, can be utilized in accordance with embodiments of the invention.

### Candidate Tracking Server Systems

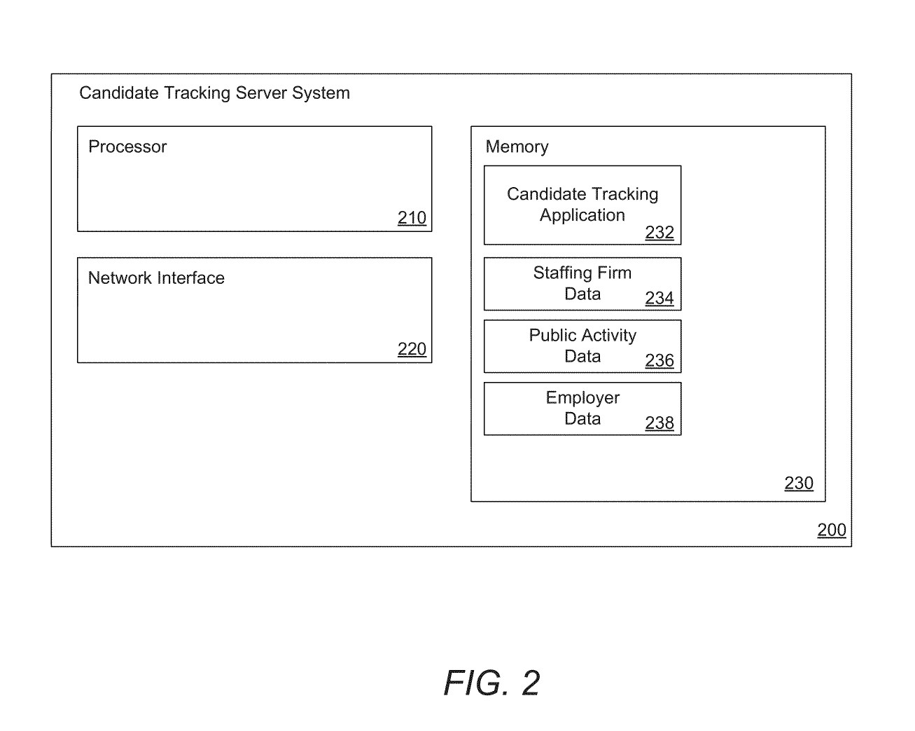

Candidate tracking server systems in accordance with embodiments of the invention can obtain a variety of data from publicly available systems and correlate that data with private staffing data in order to identify potential fee opportunities, candidate behavior, and/or recruiter performance. A conceptual illustration of a candidate tracking server system in accordance with an embodiment of the invention is shown in FIG. 2. The candidate tracking server system 200 includes a processor 210 in communication with memory 230. The candidate tracking server system 200 also includes a network interface 220 sends and receives data over a network connection. In a number of embodiments, the network interface 220 is in communication with the processor 210 and/or the memory 230. In several embodiments, the memory 230 is any form of storage capable of storing a variety of data, including, but not limited to, a candidate tracking application 232, staffing firm data 234, public activity data 236, and employer data 238. In many embodiments, the candidate tracking application 232, staffing firm data 234, public activity data 236, and/or employer data 238 are stored using an external server system and received by the candidate tracking server system 200 using the network interface 220. For example, the employer data 238 can be stored in a variety of systems and/or databases associated with an employer, such as payroll systems, onboarding systems, and/or customer relationship management (CRM) systems.

The processor 210 is directed by the candidate tracking application 232 to perform a variety of candidate tracking processes. These processes include obtaining staffing firm data 234, public activity data 236, and/or employer data 238. These pieces of data can be obtained from any systems, such as staffing firm database systems, third party content systems, client devices, the candidate tracking server system itself, or any other system as appropriate to the requirements of specific applications of embodiments of the invention. Candidate tracking processes can further include utilizing the staffing firm data 234, public activity data 236, and employer data 238 to identify potential uncollected fees due to a staffing firm for hires made by one or more employers. Notifications of these fees can be generated and transmitted to the employers, staffing firm, and/or any of a variety of client devices as appropriate to the requirements of specific applications of the invention. In several embodiments, the candidate tracking processes include utilizing the staffing firm data 234, the public activity data 236, and/or the employer data 238 to predict future candidate behaviors, such as identifying candidates that are intending to seek new employment and/or terminate their current employment.

The staffing firm data can include, but is not limited to, data describing the candidate's relationship with the staffing firm, employment history data, employers to which the candidate has been presented, the date the staffing firm engaged with the candidate, the dates on which the candidate was referred to one or more employers, the employer currently employing the candidate, the specific recruiter(s) associated with the candidate, specific hiring managers associated with the candidate, subsidiaries and/or related firms of the employer whereby a contract may still be in force, employment start date, employment end date, third party content systems associated with the candidate, data information, demographic data, psychological profile data for the candidate, current geographic location, desired geographic location, and any other data describing one or more candidates as appropriate to the requirements of specific applications of the invention. The public activity data 236 can include a variety of keywords describing the candidate's name, current employer, sentiment regarding their current position, start date, and/or any other relevant information as appropriate to the requirements of specific applications of embodiments of the invention. The employer data 238 can include, but is not limited to, the fee arrangement between the staffing firm and the employer and contractual fee period data. Additionally, the employer data 238 can include a variety of other data related to the employment of specific employees, such as payroll data, start date data, email address data, name data, demographic data regarding one or more employees, and/or any other data as appropriate to the requirements of specific applications of embodiments of the data.

Although a specific architecture for a candidate tracking server system in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory 220 includes circuitry such as, but not limited to, memory cells constructed using transistors, that store instructions. Similarly, the processor 210 can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Calculating and Recovering Contractual Fees

As described above, staffing firms can provide potential candidates to employers. If the employer hires the candidate within an agreed-on period between the employer and the staffing firm, the staffing firm is paid a fee by the employer. However, sometimes that fee is not properly paid by the employer, such as due to oversight or by hiring the candidate at a point after the candidate was presented by the staffing firm but before the contractual fee period ended. Candidate tracking processes can include determining the current employment status of one or more candidates based on staffing firm data and public activity data. This employment status can then be compared to the employers to which the candidate(s) were referred and the fees collected from the various employers. If a fee has not been paid for a particular candidate who is later hired by an employer, a notification can be generated that indicates to the staffing firm and/or employer that further action is needed to resolve the outstanding fee. For example, a candidate's LinkedIn profile can be analyzed to determine when a candidate accepted a job at a particular employer. Similarly, the publicly available profiles of a candidate can be analyzed to determine if the candidate is posting content regarding leaving their previous employer and/or working at a new employer. In a variety of embodiments, the publicly available data is analyzed by parsing keywords present in the publicly available data to identify data related to employers, current sentiment, and/or any other data as appropriate to the requirements of specific applications of embodiments of the invention. A variety of techniques for analyzing the publicly available data that can be utilized in accordance with embodiments of the invention are described in more detail below. The publicly available data can be correlated with the staffing firm data describing to which employers the candidate was referred. If there is a match between the public and private data, it can then be determined if the appropriate fee was paid in response to the hire. If not, an indication of the missing fee can be generated.

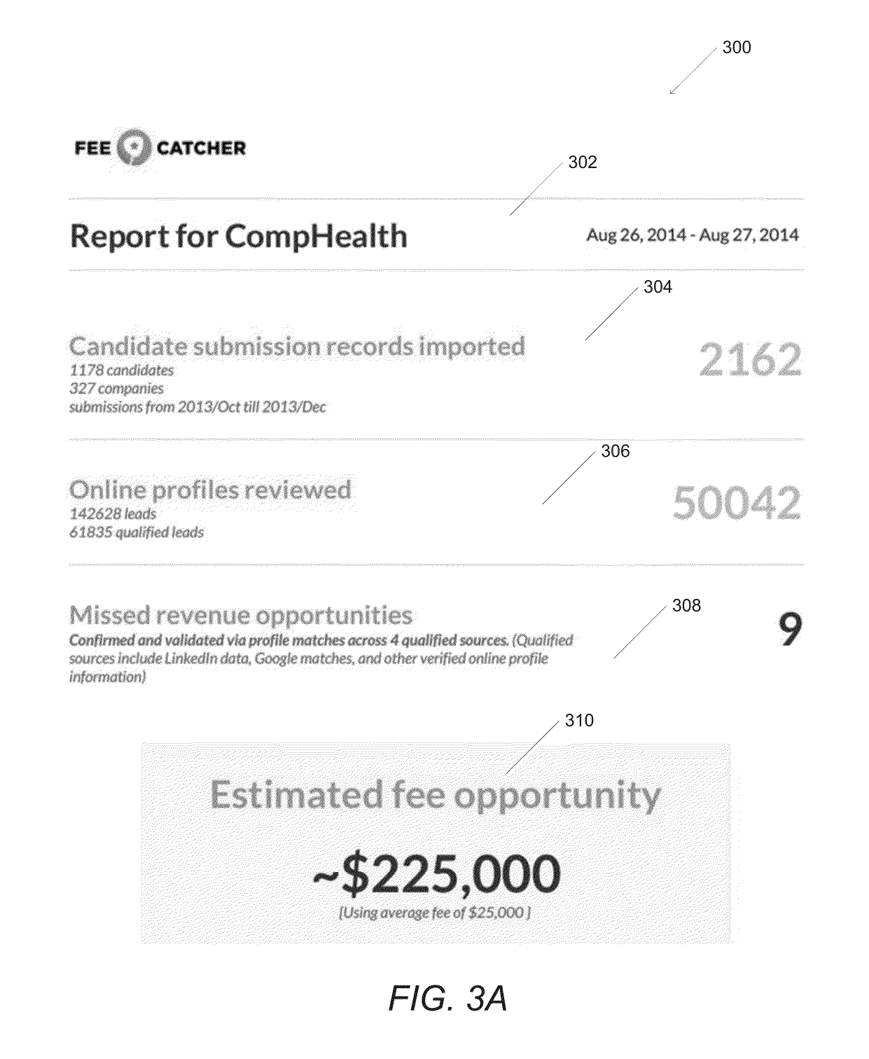

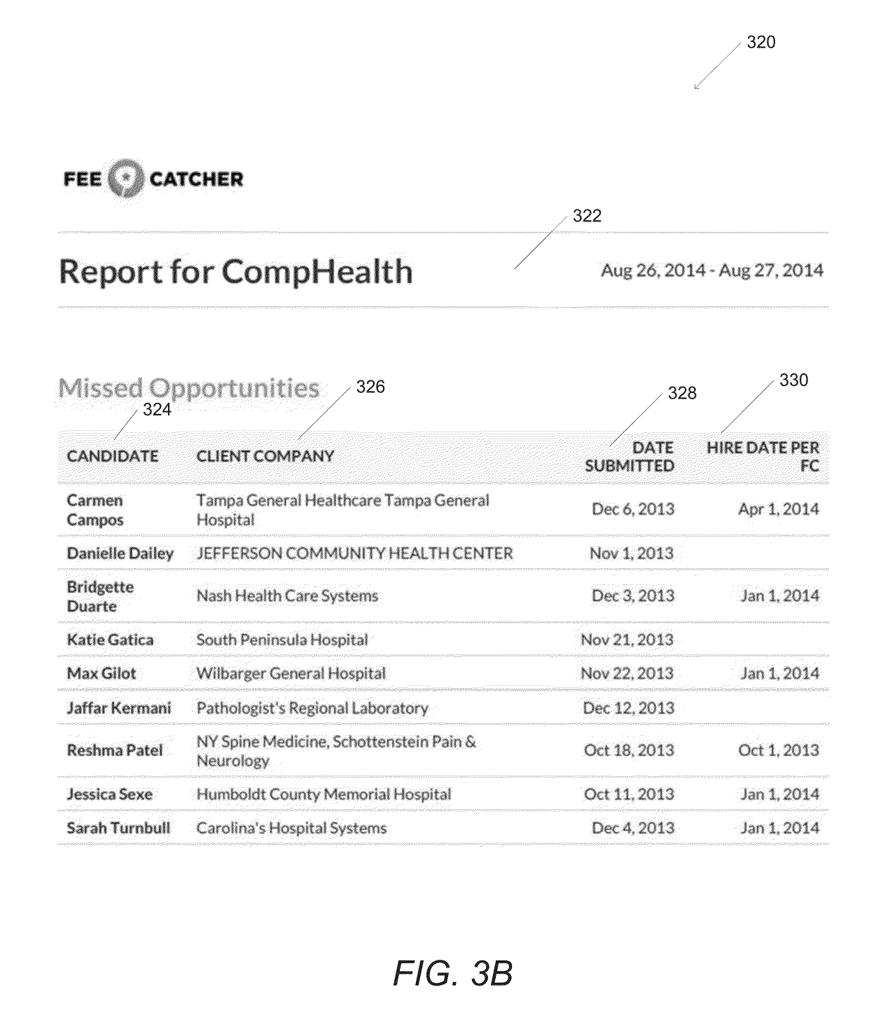

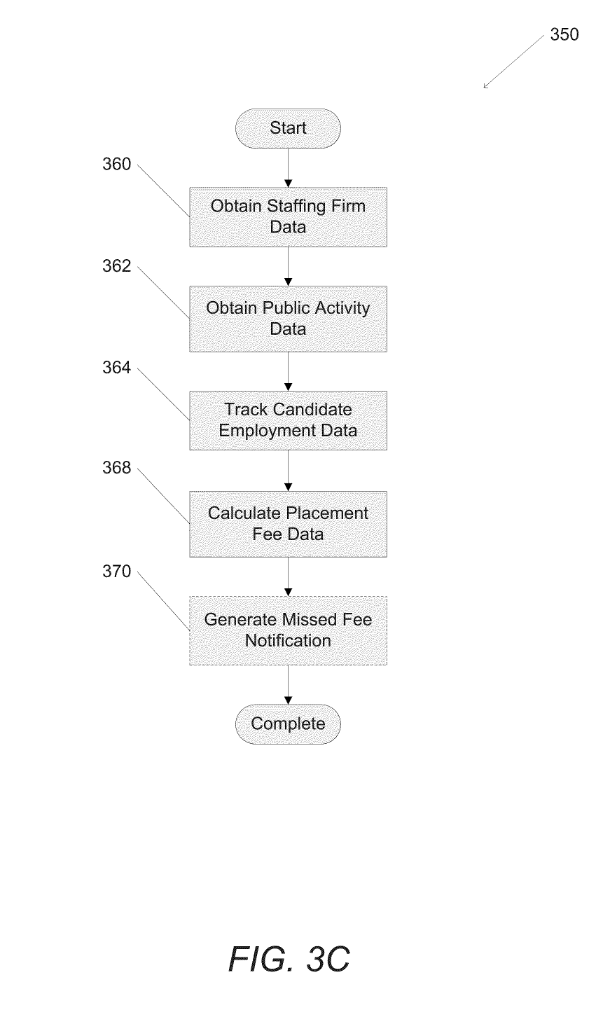

Turning now to FIG. 3A, a conceptual illustration of a user interface for identifying missed fee opportunities in accordance with an embodiment of the invention is shown. The user interface 300 can include report data 302 indicating the particular employer(s) and period for which an analysis is being provided. The user interface 300 can also include a count of staffing firm data reviewed 304 (i.e. candidate submissions and candidate data maintained by the staffing firm), a count of online profiles reviewed 306 (i.e. publicly available data taken from one or more third party content systems), along with an indication of the potentially missing fee opportunities 308. An estimate of the outstanding fees 310 can also be displayed. This estimate can be based on an average (or otherwise assumed) per-candidate fee, calculated using the fee agreements between the staffing firm and each employer, or any other estimate of the unpaid fees as appropriate to the requirements of specific applications of embodiments of the invention.

In several embodiments, potential and exact matches of candidates who are, or were, actively employed at a customer of the staffing firm (i.e., an employer or hiring firm) during the time the staffing firm placement contract was in force are generated. In a variety of embodiments, these matches are determined using a confidence function that generates a score describing the likelihood that the candidate was actually hired by a particular employer within the fee period. Criteria that can be utilized to determine potential and exact matches in accordance with embodiments of the invention include, but are not limited to, candidate name, employer of record, dates of employment, job title, company website, and candidate location.

Turning now to FIG. 3B, a conceptual illustration of a user interface for displaying matching candidates and employers in accordance with an embodiment of the invention is shown. The user interface 320 includes a set of candidates 324, a set of current employers 326, the date each candidate was submitted to the employer 328, and the hiring date of the candidate by the employer 330, if known. These dates and matches can then be utilized to identify potential fee opportunities using any of a variety of candidate tracking processes.

In a number of embodiments, staffing firm data obtained from multiple staffing firms can be combined and utilized to build a more complete set of staffing firm data describing the introductions and placements of candidates. Additionally, the staffing firm data can be audited to improve the accuracy of the candidate tracking processes.

A process for tracking candidates and determining missed fee opportunities in accordance with an embodiment of the invention is illustrated in FIG. 3C. The process 350 includes obtaining (360) staffing firm data and obtaining (362) public activity data. Candidate employment data can be tracked (364), placement fee data can be calculated (368), and, in a number of embodiments, missed fee notifications are generated (370).

Although specific processes and user interfaces for tracking candidates and identifying missed fee opportunities in accordance with embodiments of the invention are described above with respect to FIGS. 3A-C, any number of processes and user interfaces can be utilized as appropriate to the requirements of a specific application in accordance with embodiments of the invention.

### Tracking Candidates

As described above, candidate tracking systems track candidates across a variety of third party content services in order to identify publicly available information regarding the candidate's employment status. These third party content services can be provided by the candidate themselves or identified based on providing search queries to one or more third party content systems and/or search engine providers to locate information regarding the candidates. For example, a candidate's name, location, previous employers, demographic information, or any other candidate data can be provided to a third party content service to locate information regarding the candidate and/or to disambiguate the candidate from others having similar names. A variety of human expert and/or machine-performed analyses can be performed on the obtained raw data in order to extract information regarding the candidate's current employment status, such as their current employer and estimated hire date. Public activity data describing the candidate can be generated based on the analyzed raw data for the particular candidate.

In a variety of embodiments, candidate tracking server systems generate (or otherwise obtain) search queries including keywords identifying a particular candidate. The search queries can be provided to a search engine provider that will return search result data. In many embodiments, search result data includes a set of search result keywords and a set of link data associated with the keywords. Search result keywords can include relevant data describing the candidate targeted by the search query such as, but not limited to, candidate name, employers associated with the candidate, location data, and education data. The link data and/or the search result keywords can be analyzed by the candidate tracking server system to identify both raw candidate data and publicly available services (i.e. third party content systems) that can include additional data regarding the candidate. In a number of embodiments, the candidate tracking server system includes one or more parsers designed to parse raw candidate data provided by a third party content system and generate public activity data based on the parsed data. In several embodiments, multiple sources of raw candidate data are identified. The raw candidate data from one or more of the sources can be parsed and compared to determine the candidate's current employer (or any other data) as appropriate to the requirements of specific applications of embodiments of the invention. In this way, the search engine results can be utilized to better understand the candidate and provide more accurate data regarding the candidate and their current employment situation. In several embodiments, the use of search engine providers to locate raw candidate data is more efficient than querying a third party content system directly as the processing overhead needed to parse every piece of information on a third party content system is reduced.

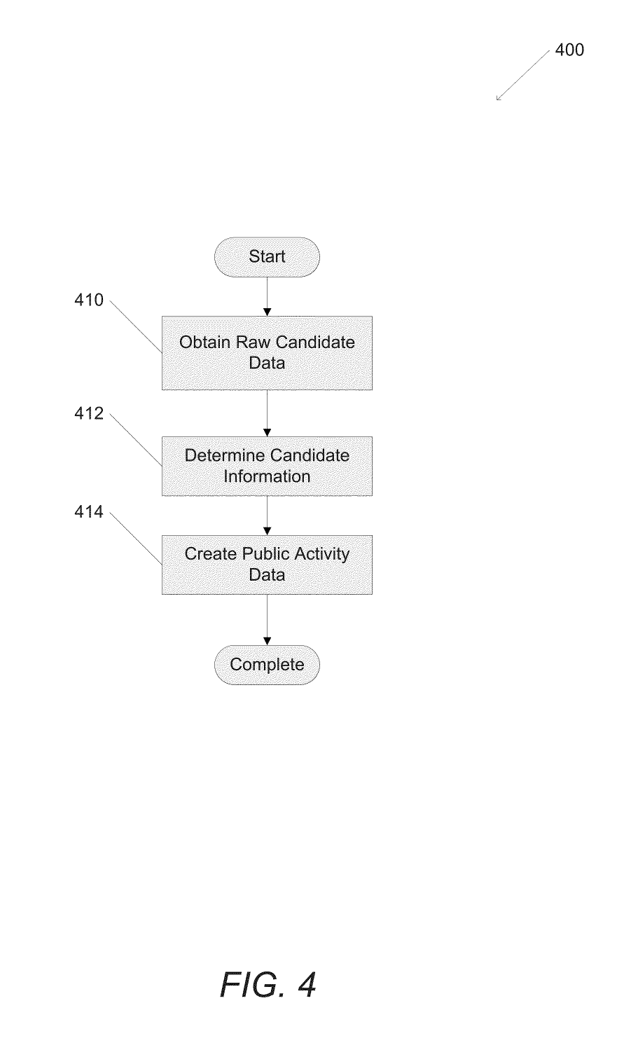

A process for tracking candidates in accordance with an embodiment of the invention is illustrated in FIG. 4. The process 400 includes obtaining (410) raw candidate data, determining (412) candidate information, and creating (414) public activity data.

Although specific processes for tracking candidates across one or more third party content systems in accordance with embodiments of the invention are described above with respect to FIG. 4, any number of processes, including those that obtain candidate employment data from employer server systems directly, can be utilized as appropriate to the requirements of a specific application in accordance with embodiments of the invention.

### Predicting Future Behavior

Companies are often interested in tracking the behavior of their employees in order to determine overall levels of satisfaction and identify potential employees who are considering leaving the company. In several embodiments, candidate tracking processes include analyze publicly available information about candidates to predict their future behavior. In a variety of embodiments, a training data set including activity data for a set of pre-selected candidates over a particular period can be generated. Any of a number of techniques can be utilized to obtain and process this training data set, including data crawlers that collect and store raw data about the candidates included in the training data set. Any of a variety of candidate data such as, but not limited to, staffing firm data, public activity data, attributes from sentiment analysis, and trends from candidates' lives, can be utilized as appropriate to the requirements of specific applications of embodiments of the invention.

In several embodiments, candidate tracking processes include obtaining a set of candidate data and generating a score describing the willingness to change jobs and/or psychological profile data for each candidate. In many embodiments, candidate tracking processes include utilizing the training data to detect signals generated using the data available for a particular candidate to generate the score describing the likelihood of the candidate to seek alternative employment. The alternative employment score can be calculated based on any of a variety of factors, including time data describing the latency between employer requests made to the employee and the action performed by the employee and/or aggregated profile data about individuals in certain roles, as appropriate to the requirements of specific applications of embodiments of the invention. For example, male software managers in California making between $140,000 and $180,000 tend to stay at a job for 2.3 years, whereas those in New York City stay 1.2 years. The aggregate data can be generated and/or provided from any of a variety of sources, included being generated based on candidate data, provided by employer server systems, and/or obtained from We would pull this based on aggregate data we receive from clients, and other publicly-available third party content systems.

In a variety of embodiments, the training data and the candidate data are utilized to build psychological model data describing the candidate. The psychological model data can include describing sentiment and trend combinations coinciding with different types of personalities. Additionally, the psychological model data can include expert analysis of a candidate's psychological profile generated by human experts and/or machine analysis (such as that performed using historical data and/or the training data) as appropriate to the requirements of specific applications of embodiments of the invention. The psychological profile data can be generated in whole or in part using any of a variety of personality testing methodologies such as, but not limited to, the Myers Briggs Type Indicator (MBTI), the MMPI, and five-factor profiles.

Turning now to FIG. 5B, a process for generating profile data for candidates is shown. The process 550 includes obtaining (560) candidate data, collecting (562) candidate-related data, and analyzing (564) candidate data. In many embodiments, probability data is calculated (566) and/or candidate behavioral data is generated (568).

Specific processes and systems for predicting candidate's future behavior in accordance with embodiments of the invention are described above with respect to FIGS. 5A-B; however, any number of processes and systems, including those that utilize techniques similar to those described above with respect to tracking candidates, can be utilized as appropriate to the requirements of a specific application in accordance with embodiments of the invention.

### Calculating Recruiter Performance

Many staffing firms employ a number of recruiters in order to effectively manage the relationships with the various employers and candidates doing business with the staffing firm. Candidate tracking processes can include identifying both high and low performing recruiters in order to improve the overall performance of the staffing firm. Additionally, weaknesses and/or strengths of the recruiting process employed by the staffing firm can be identified based on recruiter performance. One measure of recruiter performance that can be calculated in accordance with embodiments of the invention is measuring the ratio of candidate placements associated with a recruiter to the number of missed fees associated with those candidates. A second measure of recruiter performance includes identifying the value of missed fee opportunities associated with the recruiter. However, it should be noted that any processes for determining recruiter performance can be utilized as appropriate to the requirements of specific applications of embodiments of the invention.

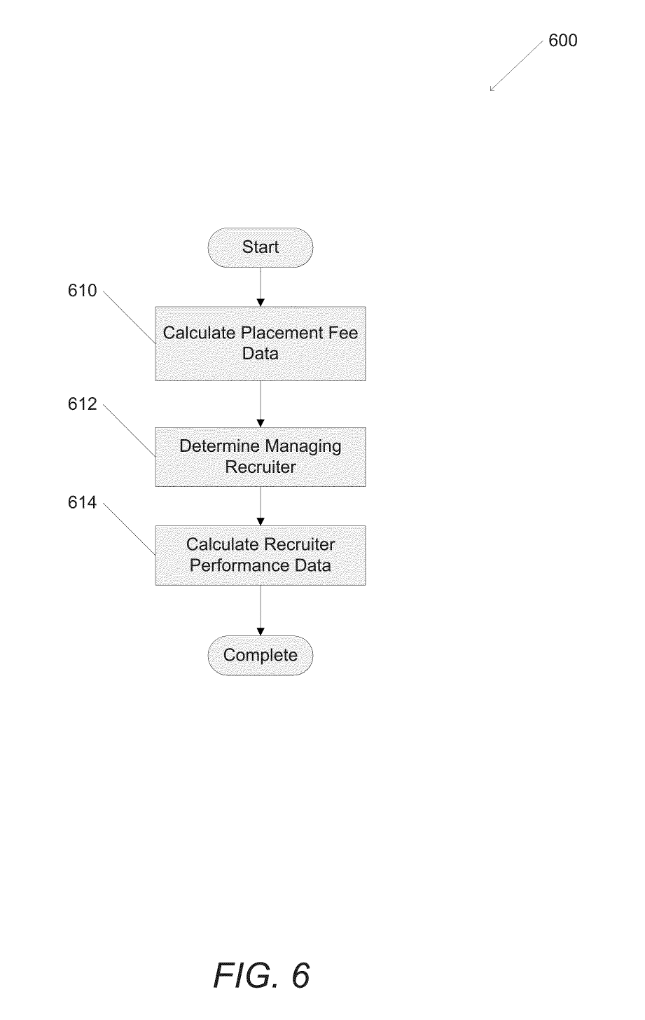

A process for determining recruiter performance in accordance with an embodiment of the invention is illustrated in FIG. 6. The process 600 includes calculating (610) placement fee data, determining (612) managing recruiter(s), and calculating (614) recruiter performance data. Specific processes for determining recruiter performance in accordance with embodiments of the invention are described above with respect to FIG. 6; however, any number of processes can be utilized as appropriate to the requirements of a specific application in accordance with embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A candidate tracking server system, comprising:
a processor; and
a memory connected to the processor and storing a candidate tracking application;
wherein the candidate tracking application directs the processor to:
obtain candidate data describing a candidate;
identify at least one publicly available data source system associated with the candidate data;
obtain public activity data for the candidate data from the at least one publicly available data source system;
determine current employment status data for the candidate data based on the obtained public activity data;
calculate fee opportunity data based on the candidate data, current employment status data, and staffing firm data, where the staffing firm data describes a relationship between an employer identified in the current employment status data and a staffing firm;
determine if the fee opportunity data has been fulfilled; and
when the fee opportunity data has not been fulfilled:
generate notification data comprising the fee opportunity data and metadata describing the employer and the staffing firm; and
provide the generated notification data.

2. The candidate tracking server system of claim 1, wherein the notification data is provided via e-mail.

3. The candidate tracking server system of claim 1, wherein the notification data is transmitted to a customer relationship management system provided by the employer.

4. The candidate tracking server system of claim 1, wherein the at least one publicly available data source system comprises an online social network.

5. The candidate tracking server system of claim 1, wherein the public activity data comprises a set of keywords.

6. The candidate tracking server system of claim 5, wherein the current employment status data is determined by parsing the public activity data to identify keywords describing the employer.

7. The candidate tracking server system of claim 1, wherein the candidate tracking application further directs the processor to generate probability data based on the candidate data and the publicly available data, where the probability data comprises a score indicating the likelihood a candidate will leave their current job.

8. The candidate tracking server system of claim 1, wherein the candidate tracking application further directs the processor to generate psychological profile data based on the candidate data and the publicly available data, where the psychological profile data comprises a set of scores.

9. The candidate tracking server system of claim 1, wherein:
the staffing firm data further comprises metadata identifying a recruiter associated with the candidate data and the employer; and
the candidate tracking application further directs the processor to calculate a set of recruiter performance scores based on the fee opportunity data.

10. The candidate tracking server system of claim 9, wherein the recruiter performance scores are selected from the group consisting of a score describing the value of missed fee opportunities and a score describing a ratio of candidate placements to missed fee opportunities.

11. A method for tracking candidates, comprising:
obtaining candidate data describing a candidate using a candidate tracking server system, where the candidate tracking server system comprises a processor and a memory connected to the processor;
identifying at least one publicly available data source system associated with the candidate data using the candidate tracking server system;
obtaining public activity data for the candidate data from the at least one publicly available data source system using the candidate tracking server system;
determining current employment status data for the candidate data based on the obtained public activity data using the candidate tracking server system;
calculating fee opportunity data based on the candidate data, current employment status data, and staffing firm data using the candidate tracking server system, where the staffing firm data describes a relationship between an employer identified in the current employment status data and a staffing firm;
determining if the fee opportunity data has been fulfilled using the candidate tracking server system; and
when the fee opportunity data has not been fulfilled:
generating notification data comprising the fee opportunity data and metadata describing the employer and the staffing firm using the candidate tracking server system; and
providing the generated notification data using the candidate tracking server system.

12. The method of claim 11, wherein the notification data is provided via e-mail.

13. The method of claim 11, wherein the notification data is transmitted to a customer relationship management system provided by the employer.

14. The method of claim 11, wherein the at least one publicly available data source system comprises an online social network.

15. The method of claim 11, wherein the public activity data comprises a set of keywords.

16. The method of claim 15, wherein the current employment status data is determined by parsing the public activity data to identify keywords describing the employer.

17. The method of claim 11, further comprising generating probability data based on the candidate data and the publicly available data using the candidate tracking server system, where the probability data comprises a score indicating the likelihood a candidate will leave their current job.

18. The method of claim 11, further comprising generating psychological profile data based on the candidate data and the publicly available data using the candidate tracking server system, where the psychological profile data comprises a set of scores.

19. The method of claim 11, further comprising calculating a set of recruiter performance scores based on the fee opportunity data using the candidate tracking server system, wherein the staffing firm data further comprises metadata identifying a recruiter associated with the candidate data and the employer.

20. The method of claim 19, wherein the recruiter performance scores are selected from the group consisting of a score describing the value of missed fee opportunities and a score describing a ratio of candidate placements to missed fee opportunities.
